(19) United States
(12) Patent Application Publication
(10) Pub. No.: US 2022/0414578 A1
(43) Pub. Date: Dec. 29, 2022

(54) SYSTEM AND METHOD OF IDENTIFYING AND UTILIZING AGENT EFFECTIVENESS IN HANDLING MULTIPLE CONCURRENT MULTI-CHANNEL INTERACTIONS

(71) Applicant: NICE LTD., Ra'anana (IL)

(72) Inventors: Rahul VYAS, Rodhpur (IN); Salil Dhawan, Pune (IN)

(21) Appl. No.: 17/359,670

(22) Filed: Jun. 28, 2021

(51) Int. Cl. G06Q 10/06; G06F 9/52; G09B 19/00; H04M 3/523

(52) U.S. Cl. CPC G06Q 10/06395; G06Q 10/06398; G06F 9/52; G09B 19/00; H04M 3/523

(57) ABSTRACT

A computerized-method for identifying and utilizing effectiveness of agent handling multiple concurrent multi-channel interactions is provided herein. The computerized-method includes operating of a Multiple Multi-Channel Effectiveness (MME) module. The MME module includes: (a) operating an interaction module to retrieve one or more concurrent interactions of an agent from the data storage of interactions, according to a time range; (b) calculating an MME score for the agent based on metadata of the one or more concurrent interactions which defines the ability of the agent to handle multiple concurrent multi-channel interactions simultaneously; (c) storing the calculated MME score in the data storage of agents; and (d) sending the MME score to the one or more applications to take one or more follow-up actions based on the MME score.

### TECHNICAL FIELD

The present disclosure relates to the field of data analysis for tracking efficiency of agents handling multiple concurrent multi-channel requests to align it to applications such as gaming solutions, quality management applications and other applications for follow-up actions.

### BACKGROUND

Contact center agents are often multi-skilled and can concurrently handle interactions from multiple different channels. When a contact center is operating in a multi-channel mode, each agent is equipped to handle multiple customer interactions across different channels simultaneously. This mode of operation may substantially increase the contact center performance, by improving agent productivity and utilization, as agents can serve several customers, at the same time. Therefore, it is significant for contact centers to encourage agents to elevate the agents' performance of handling multi-channel interactions to be as effective and efficient as much as they can.

Gamification is a process of applying game procedures to a non-gamified environment, such as contact center environment. Gamification solutions may be used to improve onboarding training results, increase agent motivation, improve agents' performance and rank by providing challenges, activities, quests, campaigns and tasks. These levels and activities are designed to boost agents' performance by allowing them to “level-up”. However, it is not one-and-done effort, as for any gamification project to succeed, an organization needs to align the goals of agents with those of the business itself.

Quality management solutions are commonly used in contact centers to evaluate the performance of the agents and for the assignment of relevant training or coaching programs, upon one or more indications. An Automatic Call Distribution (ACD) system has the capability to route omnichannel interactions to the agent having the needed proficiency, with the right expertise level, at the right time. Since the agents' proficiency and expertise level might change over time, the ACD system needs to be updated accordingly.

Currently, there is no technical solution which tracks efficiency of agents handling multi-channel requests and provides an indication to an application, such as a gamification solution, a quality management application or ACD system for one or more follow-up actions. Contact centers may utilize an indication as to the efficiency and effectivity of agents handling multi-channel interactions, to follow-up actions which may encourage agents to handle multiple concurrent multi-channel interactions.

Accordingly, there is a need for a system and method to determine efficiency and effectiveness of agents handling multiple concurrent multi-channel requests, to derive a ‘Multiple Multi-Channel Effectiveness Score (MMES)’ for each agent, which may indicate the level of efficiency and effectivity of the agent when the agent handles multiple concurrent multi-channel interactions, to be used in one or more applications for one or more follow-up actions.

### SUMMARY

There is thus provided, in accordance with some embodiments of the present disclosure, a computerized-method for identifying and utilizing effectiveness of agent handling multiple concurrent multi-channel interactions.

Furthermore, in accordance with some embodiments of the present disclosure, in a computerized system comprising a processor, one or more applications, a data storage of interactions, a data storage of agents, and a memory to store the data storages, the processor may be configured to operate a Multiple Multi-Channel Effectiveness (MME) module for each agent in the data storage of agents.

Furthermore, in accordance with some embodiments of the present disclosure, the operating of the MME module may include: (a) operating an interaction module to retrieve one or more concurrent interactions of an agent from the data storage of interactions, according to a time range; (b) calculating an MME score for the agent based on metadata of the one or more concurrent interactions, which defines the ability of the agent to handle multiple multi-channel interactions simultaneously; (c) storing the calculated MME score in the data storage of agents; and (d) sending the MME score to the one or more applications, to take one or more follow-up actions, based on the MME score.

Furthermore, in accordance with some embodiments of the present disclosure, one application of the one or more applications may be a gamification application. The one or more follow-up actions of the gamification application based on the MME score, may be providing at least one reward or recognition to the agent or a combination thereof. The at least one reward or recognition to the agent may be provided to the agent when the MME score is above a predefined threshold or between a predefined range.

Furthermore, in accordance with some embodiments of the present disclosure, one application of the one or more applications, may be a quality management application. The one or more follow-up actions of the quality management application based on the MME score may be assigning a coaching program by a user, such as an evaluator.

Furthermore, in accordance with some embodiments of the present disclosure, one application of the one or more applications may be an Automated Call Distribution (ACD) system. The one or more follow-up actions of the ACD system, based on the MME score may include changing attributes of routing skills of the agent.

Furthermore, in accordance with some embodiments of the present disclosure, the calculating of the MME Score (MMES) is based on formula I:

$$( I ) MMES = \frac{{\sum }_{i}^{N} MS ** Ti effective}{N} * {W}_{effective}$$

whereby:

N is a total number of multiple concurrent multi-channel interactions handled by the agent,

$$MS = \{ \begin{matrix}1 , Customers sentiment is positive across more than one channel \\ 0 , otherwise\end{matrix} ;$$

wherein

T_{i effective} equals

$$\frac{\vert Tf - Ti \vert}{T} ,$$

which is an effective time taken to handle multiple concurrent multi-channel interactions,
whereby:

Ti is an initial time when call started in any channel,

Tf is a final time taken to finish all the call,

T is a total time taken to complete N concurrent interactions,

wherein

W_{effective} equals Πᵢ₌₁^{N}Wi

whereby:

Wi is a weighting factor of each channel of the multiple concurrent multi-channel interactions,

N is a total number of multiple concurrent multi-channel interactions handled by the agent.

Furthermore, in accordance with some embodiments of the present disclosure, when the computerized-method is operating in a cloud computing environment, before operating the MME module, the computerized-method may be selecting a tenant from a data storage of tenants to operate the MME module for each agent in the data storage of agents of the selected tenant.

There is further provided, in accordance with some embodiments of the present disclosure, a computerized-system for identifying and utilizing effectiveness of handling multiple concurrent multi-channel interactions.

Furthermore, in accordance with some embodiments of the present disclosure, the computerized-system may include a processor, one or more applications, a data storage of interactions,

a data storage of agents; and a memory to store the data storages.

Furthermore, in accordance with some embodiments of the present disclosure, the processor may be operating a Multiple Multi-Channel Effectiveness (MME) module for each agent in a data storage of agents. The MME module may be configured to: (a) operate an interaction module to retrieve one or more concurrent interactions from the data storage of an agent based on a time range; (b) calculate an MME score for the agent based on metadata of the one or more concurrent interactions which defines the ability of the agent to handle multiple multi-channel interactions simultaneously; (c) store the calculated MME score in the data storage of agents; and (d) send the MME score to the one or more applications to take one or more follow-up actions based on the MME score.

### BRIEF DESCRIPTION OF THE DRAWINGS

FIGS. 1A-1B schematically illustrates a high-level diagram of a computerized-system for identifying and utilizing effectiveness of handling multiple concurrent multi-channel interactions, in accordance with some embodiments of the present disclosure;

FIG. 2 is a high-level workflow of Multiple Multi-Channel Effectiveness (MME) module, in accordance with some embodiments of the present disclosure;

FIG. 3 schematically illustrates components of a computerized system for utilizing effectiveness of handling multiple concurrent multi-channel interactions in a gamification application, in accordance with some embodiments of the present disclosure;

FIG. 4 schematically illustrates components of an example of a computerized system for utilizing effectiveness of handling multiple concurrent multi-channel interactions in a gamification application, in accordance with some embodiments of the present disclosure;

FIG. 5 schematically illustrates components of a computerized system for utilizing effectiveness of handling multiple concurrent multi-channel interactions in an Automatic Call Distributor (ACD) system, in accordance with some embodiments of the present disclosure;

FIG. 6 is illustrating an example of multiple multi-channel adjacency matrix, in accordance with some embodiments of the present disclosure; and

FIG. 7 is a high-level workflow of calculating an MME score for agents of one or more tenants in a cloud computing environment, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

In a report by Forrester Research, web chat came out at about half the support cost of a phone call, with an email being half the cost of that. Also, companies who provide an omnichannel customer experience achieve a 91% higher year-over-year increase in customer retention, compared to organizations who don't provide an omnichannel experience. Contact centers without omni-channel capabilities are twice as likely to incur increases in customer service costs. Moreover, contact centers with omnichannel capabilities reduced their initial contact time by 85% and led to a 20% reduction in payout time i.e., time from initial contact to completion. Agents were immediately able to answer more than 100 additional calls per day with a 12% uplift in conversion.

The research further shows that contact centers which are following a multi-channel customer strategy achieve more than twice greater, e.g., 9.7% vs. 3.9% year-over-year improvement in customer satisfaction, compared to peers using only a single channel. 83% of business using multi-channel contact centers cited improved customer experience and consistency as the main driving force. While 98% of contact centers use phone interactions as a part of their business activities, more than half of all contact centers are using at least five additional channel types, such as social media and company website to deliver customer care.

Current solutions of contact center systems don't have a technical solution which can track efficiency and effectivity of agents handling multiple concurrent multi-channel interactions and provide an indication thereof. Furthermore, there is no technical solution that utilizes such indication in other applications to take a follow-up action.

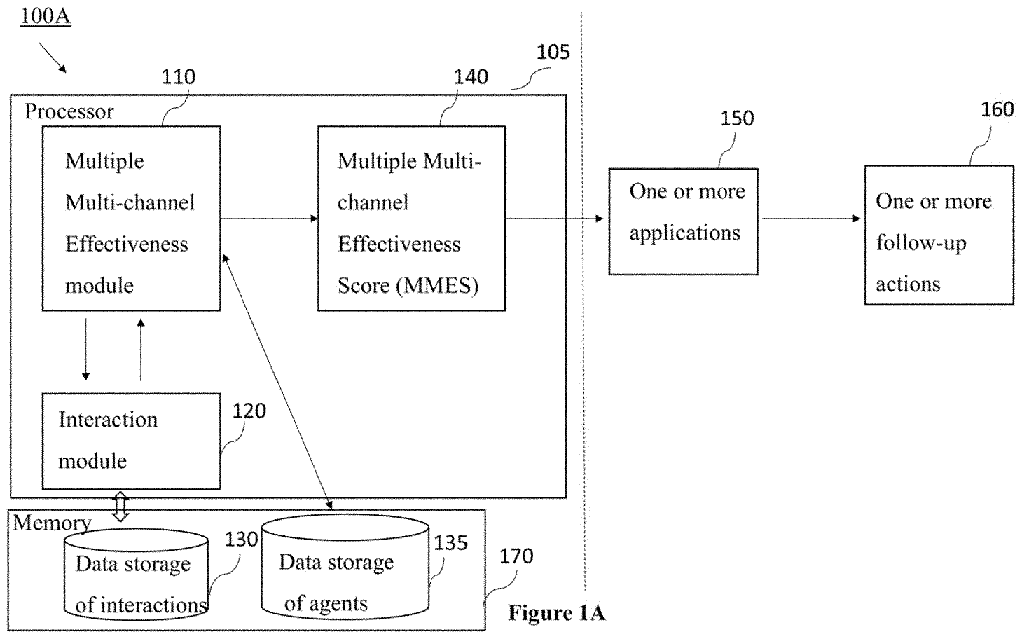

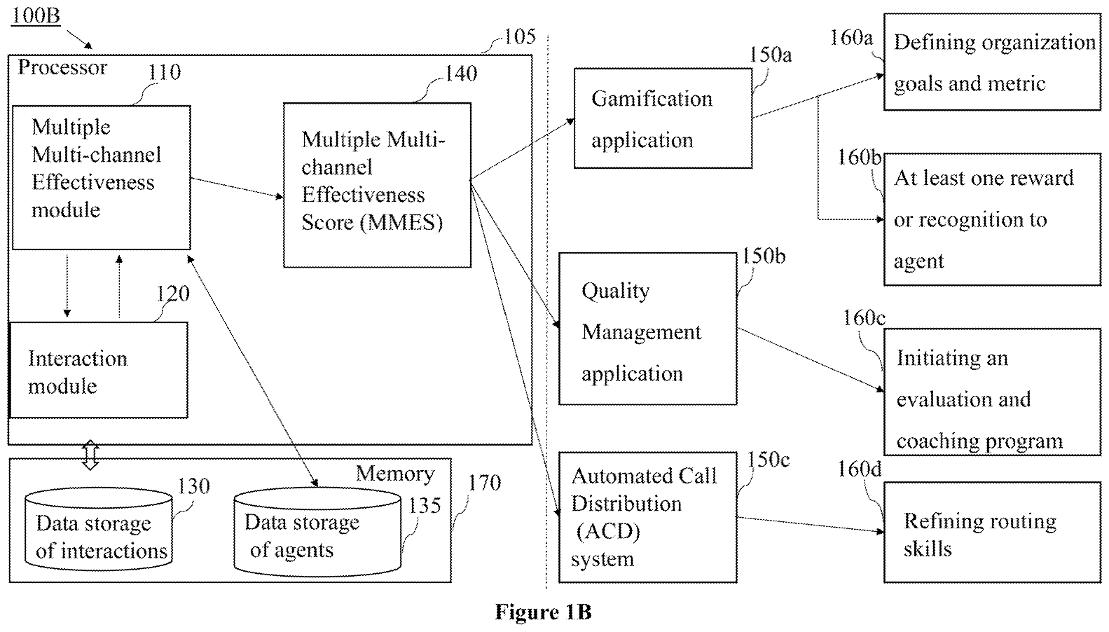

FIG. 1A schematically illustrates a high-level diagram of a computerized-system 100A for identifying and utilizing effectiveness of handling multiple concurrent multi-channel interactions, in accordance with some embodiments of the present disclosure.

According to some embodiments of the present disclosure, in a computerized system, such as computerized system 100A, which may include a processor 105, one or more applications, such as one or more applications 150, a data storage, such as data storage of interactions 130 and a data storage of agents 135, and a memory 170 to store the data storages.

According to some embodiments of the present disclosure, the processor 105 may be configured to operate a module, such as Multiple Multi-Channel Effectiveness (MME) module 110 for each agent in the data storage of agents 135.

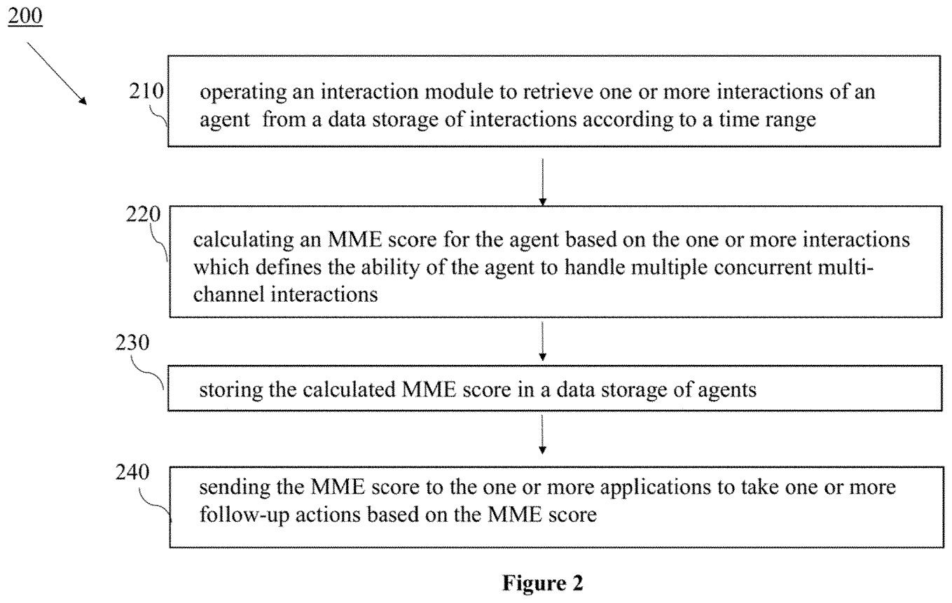

According to some embodiments of the present disclosure, a module such as MME module 110 and such as MME 200 in FIG. 2, may operate a module such as interaction module 120 to retrieve one or more concurrent interactions of an agent from the data storage of interactions 130, according to a time range.

According to some embodiments of the present disclosure, the interaction module 120 may be responsible for collecting information related to interactions from various data sources. the interaction module 120 may store all the interactions related information in a data storage, such as data storage of interactions 130 which can further be utilized MME module 110.

According to some embodiments of the present disclosure, the module, such as MME module 110 and such as MME 200 in FIG. 2, may calculate an MME Score (MMES) 140 for each agent, based on metadata of the one or more concurrent interactions. The MMES 140 may be an indication as to the ability of the agent to handle multiple concurrent multi-channel interactions simultaneously. A high MME score i.e., a score above a predefined threshold, may be an indication of agent handling multiple concurrent multi-channel interactions more efficiently and effectively. The calculated MMES 140 may be stored in the data storage of agents 135.

According to some embodiments of the present disclosure, the module, such as MME module 110 and such as MME 200 in FIG. 2, may send the MMES 140 to the one or more applications 150 to take one or more follow-up actions 160, based on the MMES 140.

FIG. 1B schematically illustrates a high-level diagram of a computerized-system 100B for identifying and utilizing effectiveness of handling multiple concurrent multi-channel interactions, in accordance with some embodiments of the present disclosure.

According to some embodiments of the present disclosure, computerized-system 100B may include the same elements as computerized-system 100A in FIG. 1A, as described in detail above. The elements may be a processor 105, which may operate an interaction module 120 to retrieve multiple concurrent multi-channel interactions of an agent, from data storage 130 and forward it to MME module 110, and such as MME 200 in FIG. 2, which may calculate MMES 140, as described above. The agent may be retrieved from a data storage of agents 135.

According to some embodiments of the present disclosure, the module, such as MME module 110 and such as MME 200 in FIG. 2, may send the MMES 140 to the one or more applications 150 to take one or more follow-up actions based on the MMES 140.

According to some embodiments of the present disclosure, the MMES 140 which may be an indication as to the efficiency and effectivity of agents handling concurrent multi-channel interactions, may be used by an application from the one or more applications 150a-150c to take one or more follow-up actions 160 in FIG. 1A.

According to some embodiments of the present disclosure, the one or more applications 150 of computerized-system 100A, in FIG. 1A, may be an application, such as a gamification solution, e.g., gamification application 150a, a quality management application, e.g., Quality Management (QM) application 150b or Automatic Call Distribution (ACD) system 150c or any combination thereof.

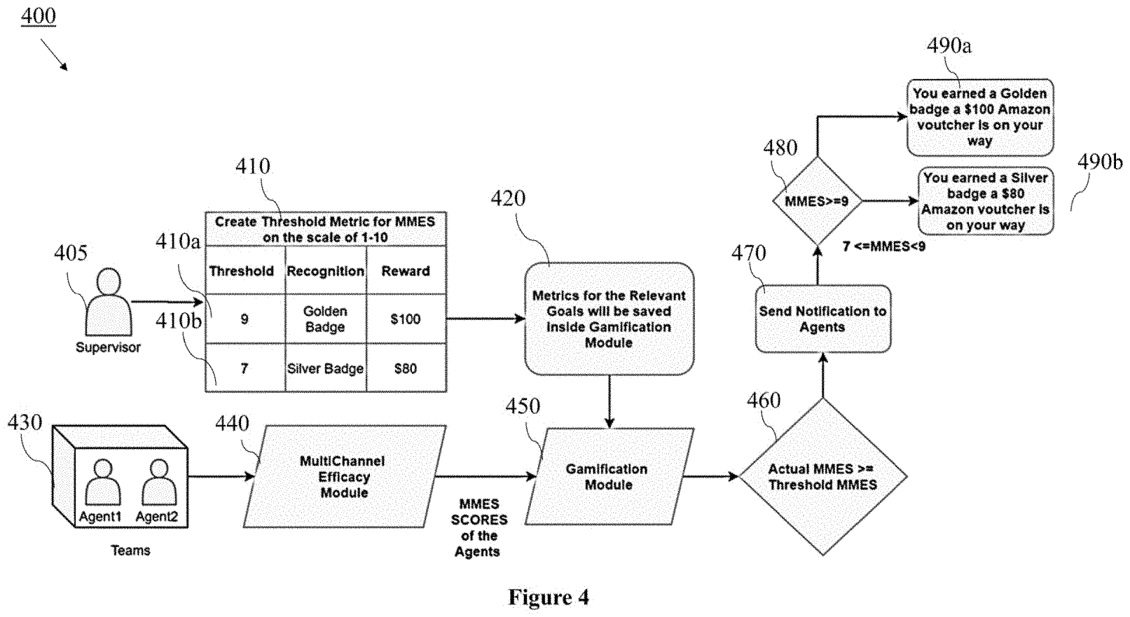

According to some embodiments of the present disclosure, when one application of the one or more applications 150 in FIG. 1A is a gamification solution, e.g., gamification application 150a, the one or more follow-up actions of the gamification application, based on the MMES 140, may be defining organization goals and metric 160a and providing at least one reward or recognition to the agent 160b. The at least one reward or recognition to the agent may be provided to the agent when the MMES 140 is above a predefined threshold or between a predefined range, as shown in detail below, in example 400, in FIG. 4.

According to some embodiments of the present disclosure, the organization goals and metric 160a are goals and metrics of an agent that a company or an organization define as a success factor. The success factor may have an impact on the growth of the company in the long run. The highest MME score of all agents in a predefined time may define one metric for the organization which will be applicable to agents engaged in handling multichannel concurrent interactions of customers.

According to some embodiments of the present disclosure, when one application of the one or more applications 150 in FIG. 1A is a quality management application, e.g., QM application 150b, the one or more follow-up actions of the QM application 150b, based on the MMES 140, may be initiating an evaluation and coaching program 160c to the agent by an evaluator. When the MMES 140 may be below a predefined threshold, the agent may be assigned by an evaluator to a coaching program.

According to some embodiments of the present disclosure, the MMES 140 can be a data point for agent handling multiple concurrent interactions, for the evaluator to evaluate the call i.e., interaction and provide an evaluation score along with coaching. For example, when the MMES 140 is considerably good i.e., above a predefined threshold, then there will be no need to assign a coaching program to the agent. Otherwise, when the MME score is poor, i.e., below a predefined threshold, then relevant coaching or training programs may be assigned to the agent.

According to some embodiments of the present disclosure, one of the one or more applications may be ACD system 150c. The one or more follow-up actions of the ACD system 150c, based on the MMES 140, may include refining attributes of routing skills 160d of the agent. For example, if the agent can handle multiple concurrent multi-channel interactions effectively and efficiently i.e., high MMES 140, then the attributes of the routing skills of the agent can be changed from beginner to expert.

In yet another example, MMES 140 may be utilized as a key input to skill-based routing which in-turn may improve performance and productivity of the agent by routing to the agent interactions which are more in line with the agent concurrent multichannel interactions capabilities thus reducing the agent average time in each interaction and allowing the agent to assist to more customers more efficiently than before.

According to some embodiments of the present disclosure, the module, such as MME module 110 and such as MME 200 in FIG. 2, may calculate an MME Score (MMES) 140 for each agent, based on metadata of the one or more concurrent interactions. The metadata of the one or more interactions of the agent, may include start and end time of each interaction of the one or more concurrent interactions, channel type of each interaction of the one or more concurrent interactions and sentiment of a customer during each interaction of the one or more concurrent interactions. The sentiment during the multiple concurrent multi-channel interactions, i.e., Multichannel Score (MS) may equal ‘1’ when the sentiment of the customer across more than one channel is positive and may equal ‘0’ otherwise.

According to some embodiments of the present disclosure, a data utilizer module may be responsible for receiving interactions and utilize the MMES in applications such as QM application, gamification application and ACD system.

According to some embodiments of the present disclosure, a score such as MMES 140 may be calculated by a module MME module 110 and such as MME 200 in FIG. 2, every duty cycle e.g., 3 hours, which is a time range that may be preconfigured. For each time range, for each agent concurrent multichannel interactions may be derived from the retrieved one or more concurrent interactions of an agent. For example, during the time range an agent may handle concurrent interactions on an audio channel, email and chat. An agent may start talking with a customer via an audio channel and at the same time another customer may be routed to the agent via a chat channel and agent may start answering to those two interactions by handling the audio concurrently. In this example, N which is the value of total concurrent multichannel interactions equals 2.

According to some embodiments of the present disclosure, in another example when an agent has handled during a duty cycle of 3 hours, a total number of complex channel handled by the agent, e.g., four concurrent multiple multichannel interactions, and in each one of the four concurrent multiple channel interactions i.e. the total number of interactions handled by the agent in one complex channel, the agent has handled three concurrent interactions in three different channels, e.g., audio, chat and email, then N may equal four times three which is twelve. A complex channel may define the agent handling concurrent multichannel interactions. One complex channel is a collection of all multichannel interactions handled by the agent.

According to some embodiments of the present disclosure, N may be calculated for each duty cycle by the following formula:

$$N = {\sum }_{i = 1}^{i = C} Ii$$

whereby:

C is a total number of complex channel handled by the agent
Ii is a total number of interactions handled by the agent in one complex channel

According to some embodiments of the present disclosure, the MME score may be calculated by MME module 110 by formula I:

$$MMES = \frac{{\sum }_{i}^{N} MS ** Ti effective}{N} * {W}_{effective}$$

whereby:
N is a total number of multiple concurrent multi-channel interactions handled by the agent,

$$MS = \{ \begin{matrix}1 , Customers sentiment is positive across more than one channel \\ 0 , otherwise\end{matrix} ;$$

wherein
T_{i effective} equals

$$\frac{\vert Tf - Ti \vert}{T} ,$$

which is an effective time taken to handle multiple concurrent multi-channel interactions,
whereby:
Ti is start time of an interaction,
Tf is end time of an interaction,
T is a total time taken to complete N concurrent interactions,
wherein
W_{effective} equals Πᵢ₌₁^{N}Wi
whereby:
Wi is a weighting factor of each channel type of the multiple concurrent multi-channel interactions,
N is a total number of multiple concurrent multi-channel interactions handled by the agent.

According to some embodiments of the present disclosure, the computerized-system, such as computerized-system 100B may be operating in a cloud computing environment. Therefore, before the processor 105 is operating the MME module 110, the processor 105 may be operating a module to select a tenant from a data storage of tenants (not shown) to operate the MME module 110 for each agent in a data storage of agents of the selected tenant.

FIG. 2 is a high-level workflow of Multiple Multi-Channel Effectiveness (MME) module, in accordance with some embodiments of the present disclosure.

According to some embodiments of the present disclosure, operation 210 may comprise operating an interaction module to retrieve one or more interactions of an agent from a data storage of interactions according to a time range. The interaction module may be a module, such as interaction module 120 in FIGS. 1A-18. The data storage of interactions may be a data storage, such as data storage of interactions 130 in FIG. 1A.

According to some embodiments of the present disclosure, operation 220 may comprise calculating an MME score for the agent based on the one or more interactions which defines the ability of the agent to handle multiple concurrent multi-channel interactions. The MME score may be a score such as MMES 140 in FIG. 1A.

According to some embodiments of the present disclosure, operation 230 may comprise storing the calculated MME score in a data storage of agents. The data storage of agents may be a data storage, such as data storage 135 in FIG. 1A.

According to some embodiments of the present disclosure, operation 240 may comprise sending the MME score to the one or more applications to take one or more follow-up actions based on the MME score. The one or more applications may be one or more applications such as one or more applications 150 in FIG. 1A.

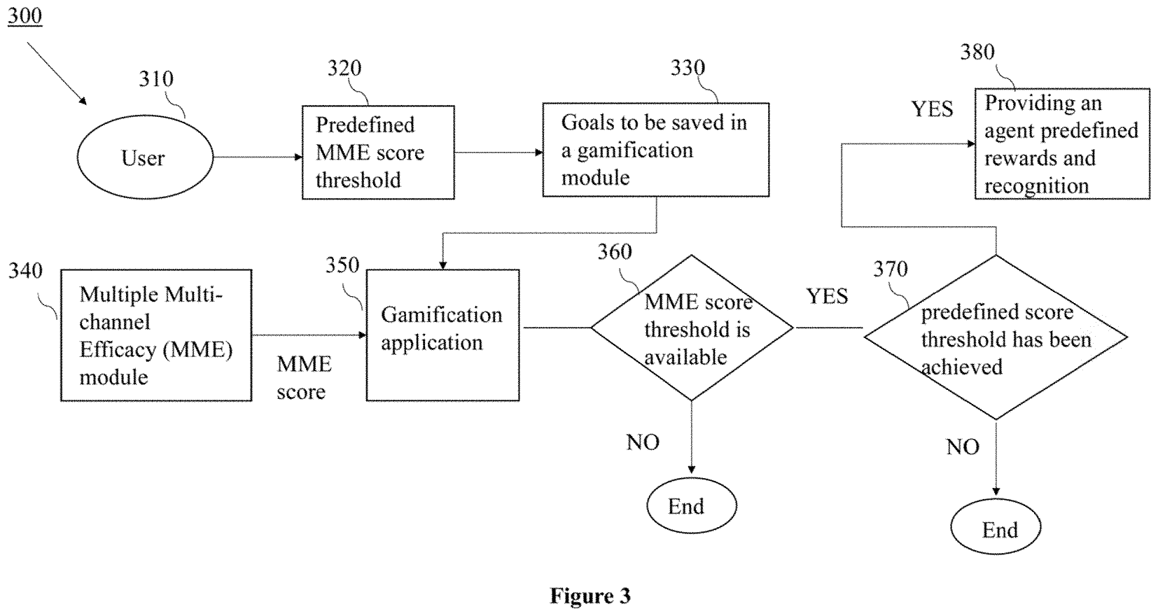

FIG. 3 schematically illustrates components of a computerized system 300 for utilizing effectiveness of handling multiple concurrent multi-channel interactions in a gamification application, in accordance with some embodiments of the present disclosure.

Gamification solutions are commonly used to motivate agents and to improve their performance and rank by providing challenges, activities, quests, campaigns and tasks. These levels and activities are designed to boost the agents' performance by allowing them to “level-up”. For any gamification project to succeed, an organization needs to align the goals of agents with those of the business itself.

According to some embodiments of the present disclosure, a user, such as user 310 may predefine an MME score threshold 320 and may set goals to be saved in a gamification module 330. For example. The threshold may be set to be above ‘9’, as shown in element 410a, in example 400, in FIG. 4. In another example, the threshold may be set to be between a predefined range, such as 7<=MMES<9 as shown in element 410b, in example, 400 in FIG. 4.

According to some embodiments of the present disclosure, a module, such as MME module 340, and such as MME module 110 in FIGS. 1A-1B, may calculate an MME score (MMES), such as MMES 140 in FIGS. 1A-1B and may send it to an application such as a gamification application 350, and such as gamification application 150a in FIG. 1B to take one or more follow-up actions, such as one or more follow-up actions 160 in FIG. 1A, and such as initiating an evaluation and coaching program 160c in FIG. 1B, based on the MMES.

According to some embodiments of the present disclosure, the gamification application 350, such as gamification application 150a in FIG. 1B, may check if MMES threshold is available 360, i.e. an MMES threshold has been predefined and if goals has been set and saved in the gamification application 350.

According to some embodiments of the present disclosure, in case a threshold of MMES has been predefines and goals have been set, the MME module 340 may check if the predefined score threshold has been achieved 370. The check if the predefined score threshold has been achieved 370 may be performed by comparing the MMES of the agent to the predefined MMES threshold.

According to some embodiments of the present disclosure, when the predefined score threshold has been achieved, the MME module 340 may provide the agent predefined rewards and recognition 380.

FIG. 4 schematically illustrates components of an example 400 of a computerized system for utilizing effectiveness of handling multiple concurrent multi-channel interactions in a gamification application, in accordance with some embodiments of the present disclosure.

According to some embodiments of the present disclosure, a user, such as a supervisor 405, may predefine a threshold MMES and may set goals. The metrics for the goals may be saved in a gamification module 420. Based on an MMES, such as MMES 140 in FIGS. 1A-1B, which has been calculated by MME module, such as MME module 110 in FIGS. 1A-1B, some rewards and recognition may be provided.

For example, the threshold may be MMES above 9 as in element 410a, which may assign the agent a recognition of golden badge and a reward of $100. The threshold may be MMES between a predefined range, such as 7<=MMES<9 as shown in element 410b, which may assign the agent with a silver badge and a reward of $80. Such a metric 410 may be created and saved inside the gamification application, e.g., predefine an MME score threshold 320 and may set goals to be saved in a gamification module 330 in FIG. 3.

According to some embodiments of the present disclosure, in a team such as team 430 for each agent an MMES, such as MMES 140 in FIGS. 1A-1B, may be calculated for handling multiple concurrent multi-channel interactions in a predefined range of time by an MME module 440, such as MME module 110 in FIGS. 1A-1B. the MMES, such as MMES 140 in FIGS. 1A-1B may be sent to a gamification module 450, which has already been provided with a metric of MMES threshold recognition and reward, such as metric 410.

According to some embodiments of the present disclosure, the calculated MMES of each agent in the team 430, may be compared with the threshold in a predefined metric, such as metric 410, e.g., actual MMES>=threshold MMES 460. When the calculated MMES of one or more agents complies with the conditions in metric 410 then the gaming application may take a follow-up action such as send a notification to agents 470.

According to some embodiments of the present disclosure, for example, when the calculated MMES of an agent may be above 9, according to metric 410, the agent may receive a notification “you earned a golden badge a $100 Amazon voucher is on your way” 490a.

According to some embodiments of the present disclosure, in another example, when the calculated MMES of an agent may be between the range of 7 and 9, e.g., 7<=MMES<9, according to metric 410, the agent may receive a notification “you earned a silver badge a $80 Amazon voucher is on your way” 490b.

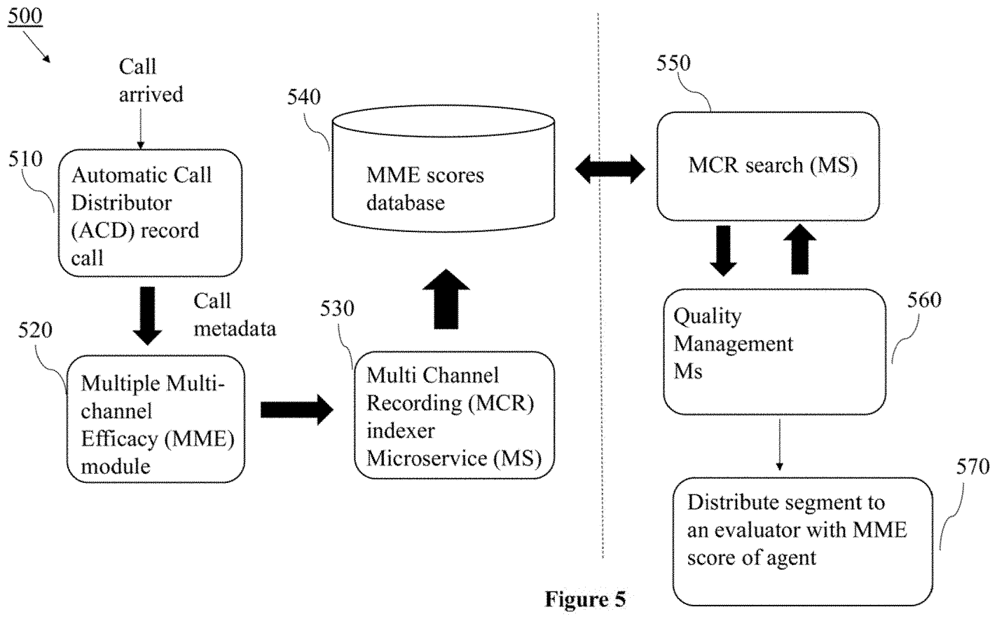

FIG. 5 schematically illustrates components of a computerized system 500 for utilizing effectiveness of handling multiple concurrent multi-channel interactions in a Quality Management system, in accordance with some embodiments of the present disclosure.

According to some embodiments of the present disclosure, after a call may arrive in a contact center and Automatic call Distributor (ACD) 510 may record the call the ACD may forward the call metadata to a MME module 520, such as MME module 110 in FIGS. 1A-1B and MME module 200 in FIG. 2.

According to some embodiments of the present disclosure, the MME module 520 may forward the metadata to Multi Channel Recording (MCR) indexer Microservice (MS) 530 which may store the call metadata in MME score database 540. The MME score database may be a part of data storage of agents, such as data storage of agents 135 in FIGS. 1A-1B.

According to some embodiments of the present disclosure, a Quality Management MS, such as QM 560, and such as QM application 150b in FIG. 1B, may retrieve MMES for an agent from MME score database 540 by MCR search 550.

According to some embodiments of the present disclosure, the QM MS 560 may distribute a segment to an evaluator with the MMES of the agent 570 for one or more follow-up actions. A segment may be an interaction channel type such as voice, chat, email, voice screen and the like.

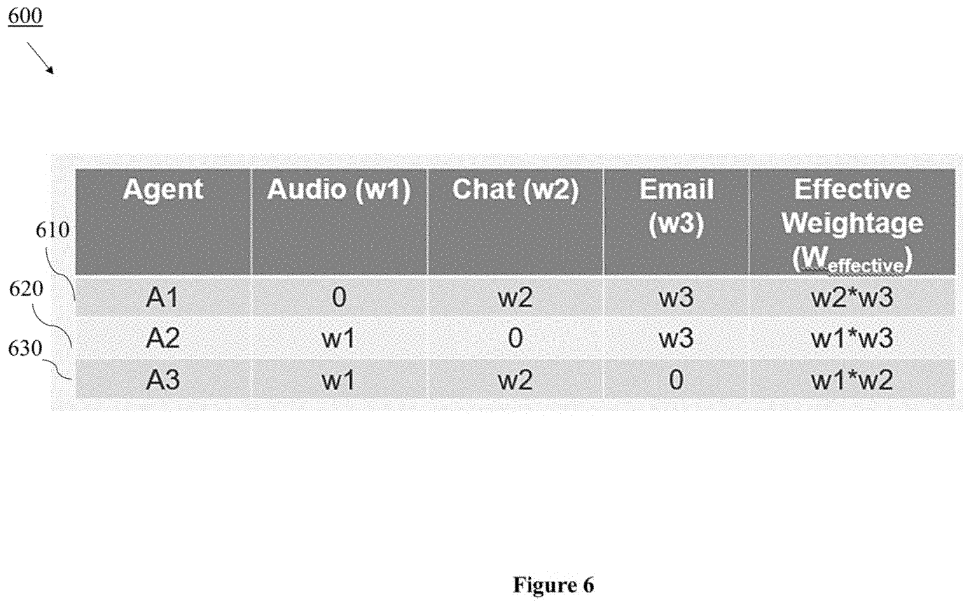

FIG. 6 is illustrating an example of multiple multi-channel adjacency matrix 600, in accordance with some embodiments of the present disclosure.

According to some embodiments of the present disclosure, a weighting factor may define the weightage of each agent handling concurrent interactions with customers on multiple concurrent multi-channels interactions. Each channel may be assigned with some weightage. The weighting factor may be higher for channels on which incoming call traffic is usually higher.

According to some embodiments of the present disclosure, the example of multiple multi-channel adjacency matrix 600 shows how effective weightage, e.g., W_{effective} may be calculated.

According to some embodiments of the present disclosure, for example, for agents A1, A2 and A3 which are handling customers on all three channels concurrently, e.g., audio, chat and email and weighting factor Wi, e.g., w1, w2 and w3, may be assigned to the audio, chat and email respectively.

According to some embodiments of the present disclosure, in the example of multiple multi-channel adjacency matrix 600 the effective weightage W_{effective} of agent A1=w2*w3 as shown by element 610, W_{effective} of agent A2=w1*w3, as shown by element 620 and W_{effective} of agent A3=w1*w2, as shown by element 630.

According to some embodiments of the present disclosure, as shown in the example of multiple multi-channel adjacency matrix 600a weightage may be assigned to each type of channel. For example, the weightage of audio may be w1, the weightage of email may be w2 and the weightage of chat may be w3.

According to some embodiments of the present disclosure, Wi, such as, W₁, W₂ and W₃ may be a weighting factor which may be assigned to each channel type of the multiple concurrent multi-channel interactions, according to the following formula:

$$Wi = \frac{T}{D}$$

### Whereby:

T is a total interaction volume occurred for a channel type in previous duty cycle.
D is duty cycle time range, which has been configured for MME module to run

According to some embodiments of the present disclosure, the precedence of weighting factor may be assigned as w1>w2>w3, i.e. (audio>chat>email).

According to some embodiments of the present disclosure, W_{effective} equals Πᵢ₌₁^{N}Wi. Wi may be a weighting factor of each channel type of the multiple concurrent multi-channel interactions for an agent. N is a total number of multiple concurrent multi-channel interactions handled by the agent. In example 600 N equals two.

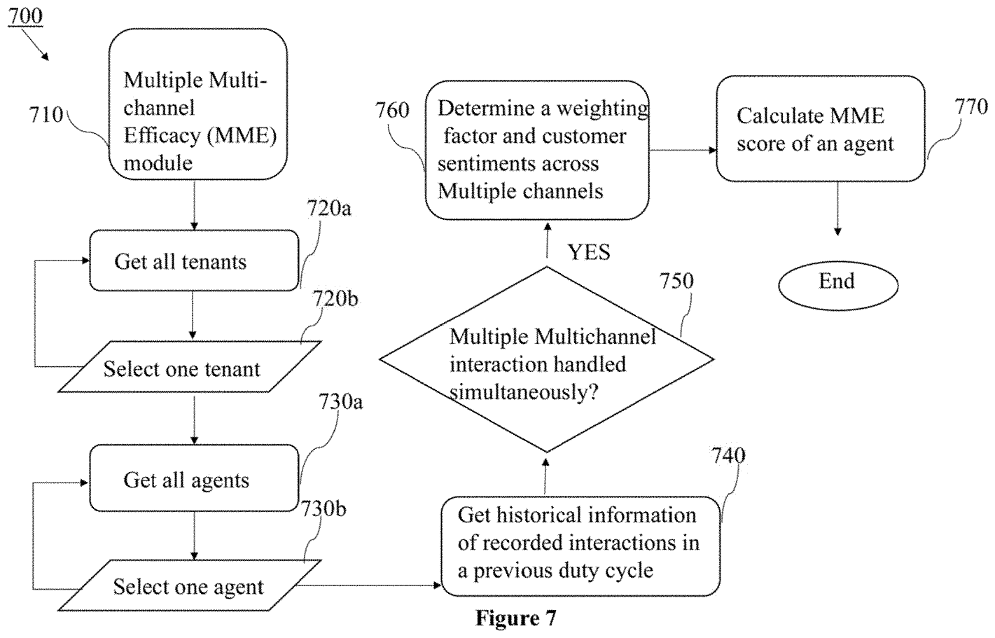

FIG. 7 is a high-level workflow of calculating an MME Score for agents of one or more tenants in a cloud computing environment, in accordance with some embodiments of the present disclosure.

According to some embodiments of the present disclosure, a duty cycle is a time period in which a module runs periodically.

According to some embodiments of the present disclosure, when a computerized system, such as computerized system 100A in FIG. 1A is operating in a cloud computing environment, before operating the MME module 710, such as MME module 110 in FIG. 1A, a computerized-method may operate every predefined duty cycle, a module to get all tenants 720a in the cloud computing environment and then may select a tenant 720b from a data storage of tenants (not shown) to operate the MME module 710, such as MME module 110 in FIG. 1A, for each agent in the data storage of agents of the selected tenant.

According to some embodiments of the present disclosure, the MME module 710, such as MME module 110 in FIG. 1A, may get all agents 730a and then select one agent 730b.

According to some embodiments of the present disclosure, for the selected agent, MME module 710 may get historical information of recorded interactions in a previous duty cycle 740. Then, MME module may check if multiple multi-channel interactions have been handled simultaneously 750.

According to some embodiments of the present disclosure, if multiple multi-channel interactions have been handled simultaneously, the MME module 710 may determine a weighting factor as described in detail above, in FIG. 6 and customer sentiments across multiple channels.

According to some embodiments of the present disclosure, the MME module 710 may calculate MME Score, such as MMES 140 in FIG. 1A for the selected agent. The MMES may be calculated according to formula I:

$$( I ) MMES = \frac{{\sum }_{i}^{N} MS ** Ti effective}{N} * {W}_{effective}$$

whereby:
N is a total number of multiple concurrent multi-channel interactions handled by the agent,

$$MS = \{ \begin{matrix}1 , Customers sentiment is positive across more than one channel \\ 0 , otherwise\end{matrix} ;$$

wherein
T_{i effective} equals

$$\frac{\vert Tf - Ti \vert}{T} ,$$

which is an effective time taken to handle multiple concurrent multi-channel interactions,
whereby:
Ti is start time of interaction,
Tf is end time of interaction,
T is a total time taken to complete N concurrent interactions,
wherein
W_{effective} equals Πᵢ₌₁^{N}Wi
whereby:
Wi is a weighting factor assigned to each channel type of the multiple concurrent multi-channel interactions,

$$Wi = \frac{T}{D}$$

### Whereby:

T is a total interaction volume occurred for a channel type in previous duty cycle.
D is duty cycle time range, which has been configured for MME module to run
N is a total number of multiple concurrent multi-channel interactions handled by the agent.

According to some embodiments of the present disclosure, the weight factor W of each channel type may be calculated by the formula:

$$W = \frac{T}{D}$$

### Whereby:

T is a total interaction volume occurred for a channel type in previous duty cycle.
D is duty cycle time range which has been configured for MME module. The MME module may be a module such as module 710, MME module 110 in FIG. 1 and MME module 200 in FIG. 2.
Accordingly, the weight factor may be changed based on total call volume which has arrived in the contact center on a given channel based during the duty cycle.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

1. A computerized-method for identifying and utilizing effectiveness of agent handling multiple concurrent multi-channel interactions, the computerized-method comprising:
in a computerized system comprising a processor, one or more applications, a data storage of interactions and a data storage of agents, and a memory to store the data storages, said processor is configured to operate a Multiple Multi-Channel Effectiveness (MME) module for each agent in the data storage of agents, said operating of said MME module comprising:
(a) operating an interaction module to retrieve one or more concurrent interactions of an agent from the data storage of interactions, according to a time range;
(b) calculating an MME score for the agent based on metadata of the one or more concurrent interactions which defines the ability of the agent to handle multiple multi-channel interactions simultaneously;
(c) storing the calculated MME score in the data storage of agents; and
(d) sending the MME score to the one or more applications to take one or more follow-up actions based on the MME score.

2. The computerized-method of claim 1, wherein one application of the one or more applications is a gamification application.

3. The computerized-method of claim 2, wherein the one or more follow-up actions of the gamification application based on the MME score, is providing at least one reward or recognition to the agent.

4. The computerized-method of claim 3, wherein the at least one reward or recognition to the agent is provided to the agent when the MME score is above a predefined threshold or between a predefined range.

5. The computerized-method of claim 1, wherein one application of the one or more applications is a quality management application.

6. The computerized-method of claim 5, wherein the one or more follow-up actions of the quality management application based on the MME score is assigning a coaching program by an evaluator.

7. The computerized-method of claim 1, wherein one application of the one or more applications is an Automated Call Distribution (ACD) system.

8. The computerized-method of claim 7, wherein the one or more follow-up actions of the ACD system based on the MME score includes changing attributes of routing skills of the agent.

9. The computerized-method of claim 1, wherein the metadata of the one or more concurrent interactions includes at least one of customers sentiment, start time of interaction, end time of interaction, and channel type.

10. The computerized-method of claim 9, wherein the calculating of the MME Score (MMES) is based on formula I:
$$( I ) MMES = \frac{{\sum }_{i}^{N} MS ** Ti effective}{N} * {W}_{effective}$$
whereby:
N is a total number of multiple concurrent multi-channel interactions handled by the agent,
$$MS = \{ \begin{matrix}1 , Customers sentiment is positive across more than one channel \\ 0 , otherwise\end{matrix} ;$$
wherein
T_{i effective} equals
$$\frac{\vert Tf - Ti \vert}{T} ,$$
which is an effective time taken to handle multiple concurrent multi-channel interactions,
whereby:
Ti is start time of interaction,
Tf is end time of interaction,
T is a total time taken to complete N concurrent interactions,
wherein
W_{effective} equals Πᵢ₌₁^{N}Wi
whereby:
Wi is a weighting factor of each channel type of the multiple concurrent multi-channel interactions,
N is a total number of multiple concurrent multi-channel interactions handled by the agent.

11. The computerized-method of claim 1, wherein when the computerized-method is operating in a cloud computing environment, before operating the MME module the computerized-method is selecting a tenant from a data storage of tenants to operate the MME module for each agent in the data storage of agents of the selected tenant.

12. A computerized-system for identifying and utilizing effectiveness of agent handling multiple concurrent multi-channel interactions, the computerized-system comprising:
a processor;
one or more applications;
a data storage of interactions;
a data storage of agents; and
a memory to store the data storages,
said processor is operating a Multiple Multi-Channel Effectiveness (MME) module for each agent in a data storage of agents, said MME module is configured to:
(a) operate an interaction module to retrieve one or more concurrent interactions of an agent from the data storage of interactions, according to a time range;
(b) calculate an MME score for the agent based on metadata of the one or more concurrent interactions which defines the ability of the agent to handle multiple multi-channel interactions simultaneously;
(c) store the calculated MME score in the data storage of agents; and
(d) send the MME score to the one or more applications to take one or more follow-up actions based on the MME score.

13. The computerized-system of claim 12, wherein one application of the one or more applications is a gamification application.

14. The computerized-system of claim 13, wherein the one or more follow-up actions of the gamification application based on the MME score is providing at least one reward or recognition to the agent.

15. The computerized-system of claim 14, wherein the at least one reward or recognition to the agent is provided to the agent when the MME score is above a predefined threshold or between a predefined range.

16. The computerized-system of claim 12, wherein one application of the one or more applications is a quality management application.

17. The computerized-system of claim 16, wherein the one or more follow-up actions of the quality management application based on the MME score is assigning a coaching program by an evaluator.

18. The computerized-system of claim 12, wherein one application of the one or more applications is an Automated Call Distribution (ACD) system.

19. The computerized-system of claim 18, wherein the one or more follow-up actions of the ACD based on the MME score, includes changing attributes of routing skills of the agent.

20. The computerized-system of claim 12, wherein the metadata of the one or more concurrent interactions includes at least one of: customers sentiment, start time of interaction, end time of interaction, and channel type.

21. The computerized-system of claim 20, wherein the calculating of the MME Score (MMES) is based on formula I:
$$( I ) MMES = \frac{{\sum }_{i}^{N} MS ** Ti effective}{N} * {W}_{effective}$$
whereby:
N is a total number of multiple concurrent multi-channel interactions handled by the agent,
$$MS = \{ \begin{matrix}1 , Customers sentiment is positive across more than one channel \\ 0 , otherwise\end{matrix} ;$$
wherein
T_{i effective} equals
$$\frac{\vert Tf - Ti \vert}{T} ,$$
which is an effective time taken to handle multiple concurrent multi-channel interactions,
whereby:
Ti is start time of interaction,
Tf is end time of interaction,
T is a total time taken to complete N concurrent interactions,
wherein
W_{effective} equals Πᵢ₌₁^{N}Wi
whereby:
Wi is a weighting factor of each channel type of the multiple concurrent multi-channel interactions,
N is a total number of multiple concurrent multi-channel interactions handled by the agent.
